(19) United States
(12) Patent Application Publication
(10) Pub. No.: US 2025/0218612 A1
(43) Pub. Date: Jul. 3, 2025

(54) SYSTEMS AND METHODS FOR REDUCING COOLANT BACKFLOW THROUGH A POOL-TYPE REACTOR CORE

(71) Applicant: GE-Hitachi Nuclear Energy Americas LLC, Wilmington, NC (US)

(72) Inventor: David Burnette, Wilmington, NC (US)

(21) Appl. No.: 19/006,196

(22) Filed: Dec. 30, 2024

Related U.S. Application Data
(60) Provisional application No. 63/616,570, filed on Dec. 30, 2023.

(51) Int. Cl. G21C 15/247; G21C 1/03; G21C 15/12; G21C 15/28

(52) U.S. Cl. CPC G21C 15/247; G21C 1/03; G21C 15/12; G21C 15/28

(57) ABSTRACT

Systems limit backflow through a nuclear reactor cores from a hot pool to a cold pool. Example systems include coolant risers and/or one-way flow structures before a coolant inlet for the reactor. The coolant riser provides coolant that will flow under gravity alone into the reactor despite hot pool pressure head. Fluidic diodes and/or check-valves prevent nearly all reverse flow. Such structures may be positioned with the flow limiter before the riser in the normal direction of coolant flow into the inlet. Such structures may be positioned anywhere they can functionally provide coast down cooling and prevent reverse flow, including as a pump annulus or pool. For a sodium-cooled fast reactor, the riser and fluidic diode may provide sufficient volume to cool the reactor with forward coolant flow for an entire reactor coast down period, when the reactor is shut down and generating only decay heat.

### RELATED APPLICATIONS

This application claims priority under 35 U.S.C. § 119 to U.S. Provisional Application 63/616,570, filed Dec. 30, 2023 and incorporated by reference herein in its entirety.

### BACKGROUND

FIG. 1 is a cross-section view of a related art pool-type nuclear reactor vessel 100. As shown in FIG. 1 a fluid coolant, such as a molten metal like sodium, flows through reactor vessel module 4 and heat transport modules 6. Reactor vessel module 4 houses core 8 and receptacles 10 and is in fluid communication with heat transport modules 6. Heat transport modules 6 include one or more pumps 12, one or more heat exchanger 14, a discharge plenum 16, and various piping. Heat exchanger 14 may be a steam generator or intermediate sodium heat exchanger, for example, extracting heat from the fluid coolant for use in driving a turbine and generator for generating electricity. Upper internal structure 18 may also be provided to provide guides for control rods, drivelines, and instrumentation, as well as flow path for cooling exiting core 8.

Fluid coolant may flow through the modules as indicted by the arrows of FIG. 1, being driven by one or more pumps 12, into the bottom of core 8, up through reactor vessel 4, into heat exchanger 14, and returning to pump 12. Of course, other components may be present, such as more than one pump, additional heat exchangers, and others. Coolant level exiting core 8 into hot pool 22 may be vertically higher than coolant level exiting heat exchanger 14 into cold pool 20 that may surround the same, owing to the temperature gradient across heat exchanger 14 and drive of pump 12.

This background provides a useful baseline or starting point from which to better understand some example embodiments discussed below. Except for any clearly-identified third-party subject matter, likely separately submitted, this Background and any figures are by the Inventor(s), created for purposes of this application. Nothing in this application is necessarily known or represented as prior art.

### SUMMARY

Example embodiments include enhancing systems for reducing backflow through a nuclear reactors having a hot pool of coolant connected to a cold pool of coolant through a heat exchanger. Example systems include coolant risers and/or one-way flow structures before a coolant inlet for the reactor. The coolant riser joins at a position such that the riser's elevation will have a greater gravity pressure head of coolant compared to coolant flowing into the inlet, such that the coolant will flow under gravity alone into the reactor. The one-way flow structures include fluidic diodes and check-valves that prevent nearly all reverse flow. Such structures may be positioned with the flow limiter before the riser in the normal direction of coolant flow into the inlet. Such structures may be positioned anywhere they can functionally provide coast down cooling and prevent reverse flow, including as a pump annulus or pool. For a sodium-cooled fast reactor, the riser and fluidic diode may provide sufficient volume to cool the reactor with forward coolant flow for an entire reactor coast down period, when the reactor is shut down and generating only decay heat.

### BRIEF DESCRIPTIONS OF THE DRAWINGS

Example embodiments will become more apparent by describing, in detail, the attached drawings, wherein similar elements are represented by similar reference numerals. The drawings serve purposes of illustration only and thus do not limit example embodiments herein. Elements in these drawings may be to scale with one another and exactly depict shapes, positions, operations, and/or wording of example embodiments, or some or all elements may be out of scale or embellished to show alternative proportions and details.

FIG. 1 is an illustration of a related art pool-type reactor.

FIG. 2 is an illustration of an example embodiment pool-type reactor system.

FIG. 3 is a schematic of the example embodiment system of FIG. 2.

FIG. 4A is an illustration of an example embodiment fluidic diode.

FIG. 4B is an illustration of another example embodiment fluidic diode.

FIG. 4C is an illustration of another example embodiment fluidic diode.

FIG. 4D is an illustration of another example embodiment fluidic diode.

FIG. 4E is an illustration of another example embodiment fluidic diode.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

Membership terms like “comprises,” “includes,” “has,” or “with” reflect the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion. In listing items in example embodiments, conjunctions and inclusive terms like “and,” “with,” and “or” include all combinations of one or more of the listed items without exclusion of non-listed items. The use of “etc.” is defined as “et cetera” and indicates the inclusion of all other elements belonging to the same group of the preceding items, in any “and/or” combination(s). Modifiers “first,” “second,” “another,” etc. do not confine modified items to any order. These terms are used only to distinguish one element from another; where there are “second” or higher ordinals, there merely must be that many number of elements, without necessarily any difference or other relationship among those elements.

When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

The structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

Proportions, sizes, and shapes shown in the figures are examples for illustration. While they reflect features of some example embodiments, other relationships and magnitudes of dimensions are included in these examples. As used herein, “azimuthal” and “angular” directions substantially follow a rounded perimeter of a referenced feature, and “radial” directions substantially follow a radius of that rounded perimeter, perpendicular to the angular direction. “Vertical” and height directions substantially follow an up-down orientation, orthogonal to the radial and angular directions of a referenced feature. “Length” and “width” are substantially perpendicular dimensions of a referenced feature, with “length” generally being a longest dimension of the feature.

The inventors have recognized that related art pool-type reactors require that coolant flow proceed through a core to a heat exchanger, and not back out of a core, such as back through a pump or into a surrounding pool or coolant source. This is true even during shutdown periods and other times when pumped flow is unavailable. Loss of positive pressure driving this flow, such as pump head from the coolant pumps, can lead to a reversal in flow direction. Even after shutdown, this can cause additional further heating of the coolant already downstream of the core and potentially increase core temperature. Positive elevation head of the hot pool relative to the cold pool can provide an undesirably large volume of liquid metal available for such reversed flow. Further, some reactor designs may require a period of prolonged positive flow after shutdown to avoid a similar heat-up. The use of backup power sources, such as grid power, emergency diesel generators, batteries, etc. to achieve this increases cost and complexity. For liquid metal coolants, electromagnetic pumps offer several advantages over traditional centrifugal pumps. However, electromagnetic pumps often lack significant inertia and/or reverse flow resistance when de-energized. To overcome these newly-recognized problems as well as others, the inventors have developed example embodiments and methods described below to address these and other problems recognized by the inventors with unique solutions enabled by example embodiments.

The present invention is pool-type reactor components and methods of using the same with reduced core backflow. In contrast to the present invention, the few example embodiments and example methods discussed below illustrate just a subset of the variety of different configurations that can be used as and/or in connection with the present invention.

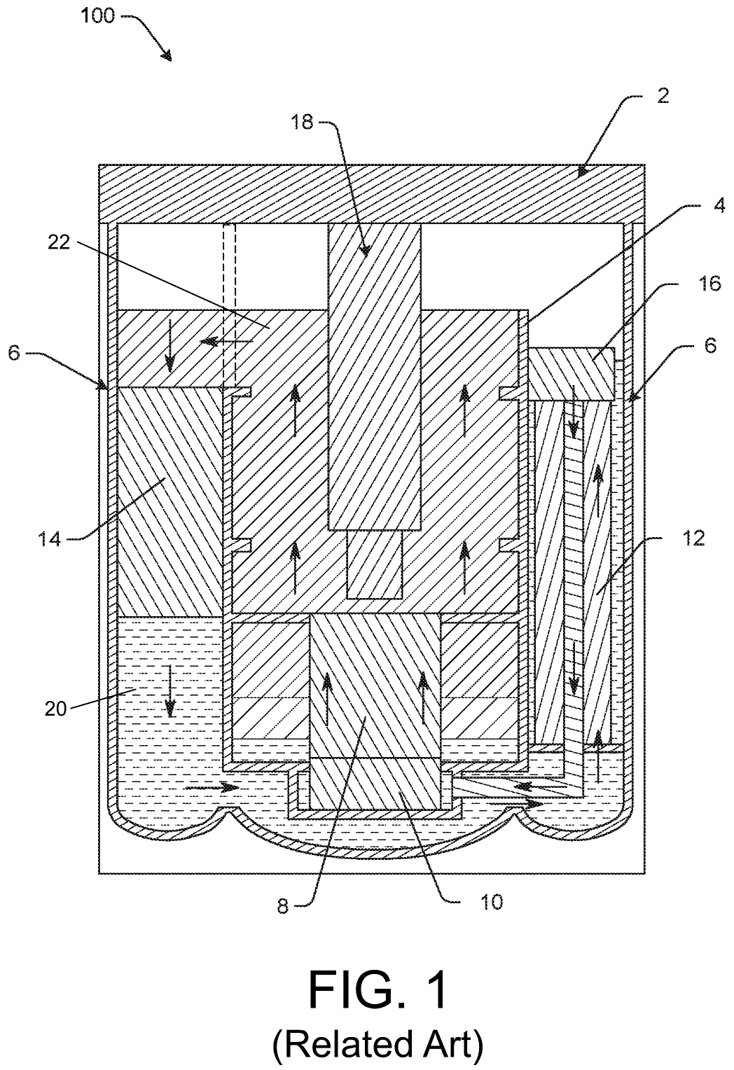

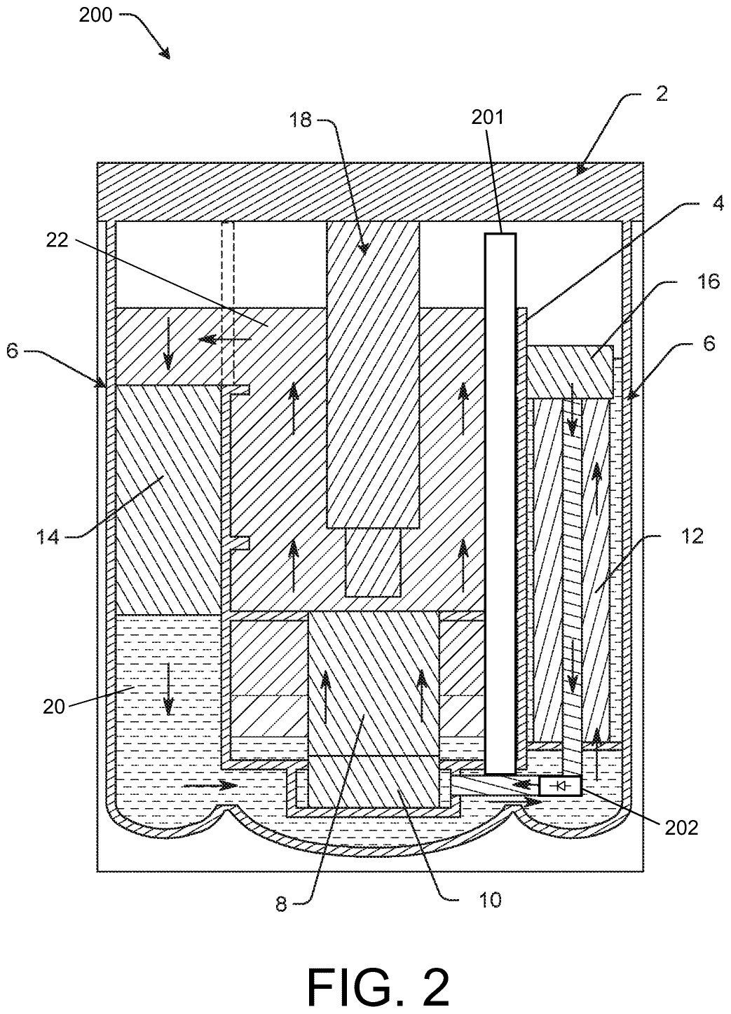

FIG. 2 is an illustration of an example embodiment pool-type reactor system 200. System 200 may include several similar elements of related pool-type reactors, including that of FIG. 1, and is useable in place of the same with proper reconfiguration. As shown in FIG. 2, example embodiment system includes at least one of cold pool riser 201 and fluidic diode 202 positioned prior to core 8. Cold pool riser 201 or fluidic diode 202 passively prevent flow reversal through core 8 upon loss of pump 12 power and/or maintain positive flow or coast down coolant flow requirements after shutdown. For example, cold pool riser 201 may ensure flow remains in the directions shown in FIG. 2 through core 8, and fluidic diode 202 may reduce or limit an amount of flow in the reverse direction.

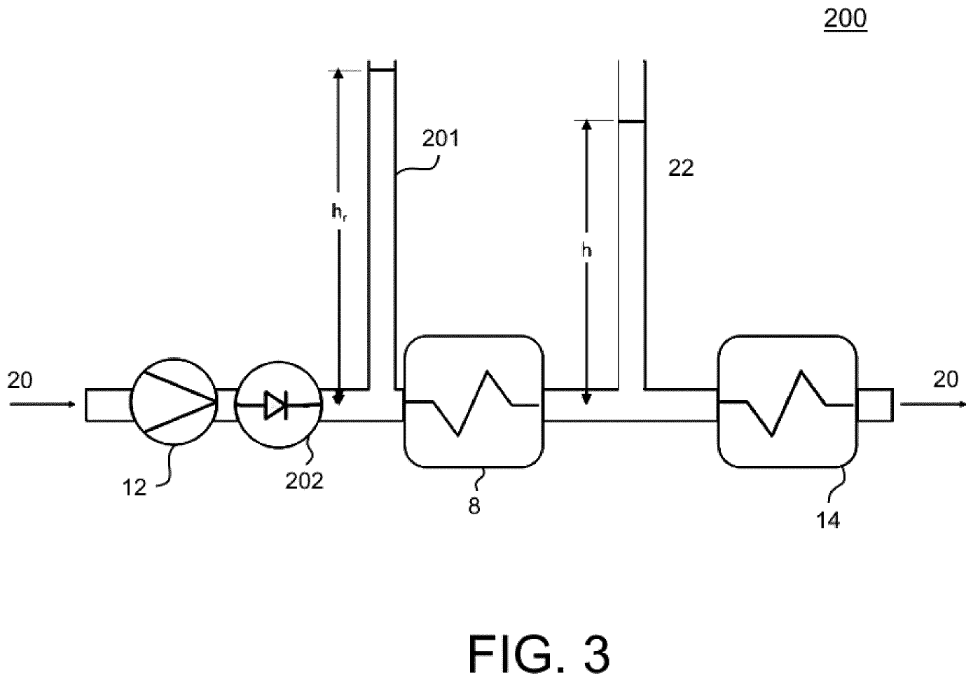

FIG. 3 is a system schematic of the example embodiment system of FIG. 2. In FIG. 3, the relative pressures or heads of hot pool 22 and cold pool riser 201 are illustrated vertically on either side of core 8. Typically, hot pool 22 has a higher vertical fluid level of an equivalent head h, because the positive pump head pulls coolant from cold pool 20, pushes it through core 8, and into hot pool 22. The flow resistance of heat exchanger 14 creates a rise in the elevation of hot pool 22 relative to cold pool 20. During a loss of power or other failure of pump 12, hot pool head h is free to dissipate via flow through core 8 or heat exchanger 14. A ratio of flow may be inversely proportional to the resistance or pressure drop across core 8 and heat exchanger 14, which both change as a function of flow rate.

Cold pool riser 201 before core 8, such as at an outlet of pump 12 or cold pool 20 provides positive flow pressure and coolant volume to maintain positive flow through core 8 to heat exchanger 14. The height of the riser, hr, may correspond to the pump head pEM, as in pEM=ρghr, and may provide a greater pressure than that of the hot pool head ρgh. Upon loss of power to pump 12, cold pool riser 201 maintains a higher pressure upstream of core 8. Cold pool riser 201 may actuate passively through a check valve or explosive valve that actuates upon detection of pump failure or reverse flow back through core 8. In this way, cold pool riser 201 may be filled, closed, and passively stored during normal operation until needed.

Although riser 201 may interface with the coolant flow between the high pressure side of pump 12 and core 8 of the reactor, it may be located at any other position, and its liquid volume can be stored at any convenient location within or external to the reactor vessel. For example, riser 201 may potentially be positioned in a reactor head penetration. Or, for example, for vertically-mounted pumps, the riser volume may be annular around the pumps, and/or the pump, diode, and riser may be contained in a single module. Several pump trains for core 8 can share single riser 201 with a large enough volume to accommodate coast down requirements for all trains or to provide positive head and continued operation with reduced trains. In this way, example embodiment system 200 can include adjoining risers 201 for multiple pumps 12 to create a cold pool “cloud” shared by all pumps in the system.

The shape and dimensions of riser 201 can be selected for any pressure and amount of injection. For example, riser 201 may be sized to provide sufficient volume to maintain forward flow until hot pool head h is depleted. The shape of the riser may provide a desired coastdown curve, such as linear or exponential decay in coolant flow to match anticipated core shutdown flows. The height and volume of the riser can be selected based on coast down requirements and system resistances. For example, to achieve full passive coast down, the volume of riser 201 may be larger. The coast down flow requirement is a function of determinable reactor core physics, and the required volume can be found from Equation 1:

$$V = {\int }_{t = 0}^{∞} {\dot{V}}_{o} {e}^{- t / τ} dt \qquad ( 1 )$$

which shows the integration of the flow rate decay equation using the expected coast down time constant. For flow in a single direction using typical values for sodium as a coolant, for example, sufficient riser volume can be achieved with little impact on reactor vessel geometry. This may include, for example, approximately 30 seconds of flow in a positive or forward direction through the reactor. Numerous combinations of minor losses, changes in elevation, and differences in cover gas pressure could be used to alter the size of the reserve coolant volume in cold pool riser 201.

Alternatively or additionally in FIG. 3, a one-way flow structure can counteract any low resistance of pump 12, to prevent or limit reverse flow through core 8. This may include fluidic diode 202, a check valve, an isolation valve, etc. at the outlet of pump 12, any cold pool outlet, or other position where reverse coolant flow is undesired. For example, fluidic diode 202 may substantially reduce such reverse flow in most liquid coolants such as liquid sodium, molten salts, water, liquid lead, etc. Fluidic diode 202 may have little to no effect on forward flow shown by arrows in FIG. 3, such that they may be installed in any number or flow path without disrupting normal operation.

If used together with riser 201, fluidic diode 202 may reduce reverse flow from riser 201 not into the core 8, and thus reduce the total riser volume required The riser and one-way flow structure may largely prevent reverse flow from the core while enabling coast down with no external, active, or electrical components. Fluidic diode 202 may be positioned anywhere, such as upstream of riser 201 or internal to pump 12 or at an intake of pump 12 intake, or inside or outside of the reactor vessel housing core 8.

Fluidic diode 202 may include many geometries, including a vortex diode, Tesla valve, etc. and sizes that can be used, depending on the needed flow rate, speed, temperature, and other parameters. The diode uses fluid properties and geometry to create a pressure drop that is a function of flow direction, which approximates the behavior of a diode with no moving parts. Fluidic diodes may be particularly effective at reducing reverse flow of higher-density coolants such as liquid sodium, melted metals, and molten salts, owing to their higher viscosity, cohesion, and flow losses in reverse through the diode, making a fluidic diode an unexpectedly effective flow limiter, providing a new functionality beyond minor flow limitation, with heavier coolants.

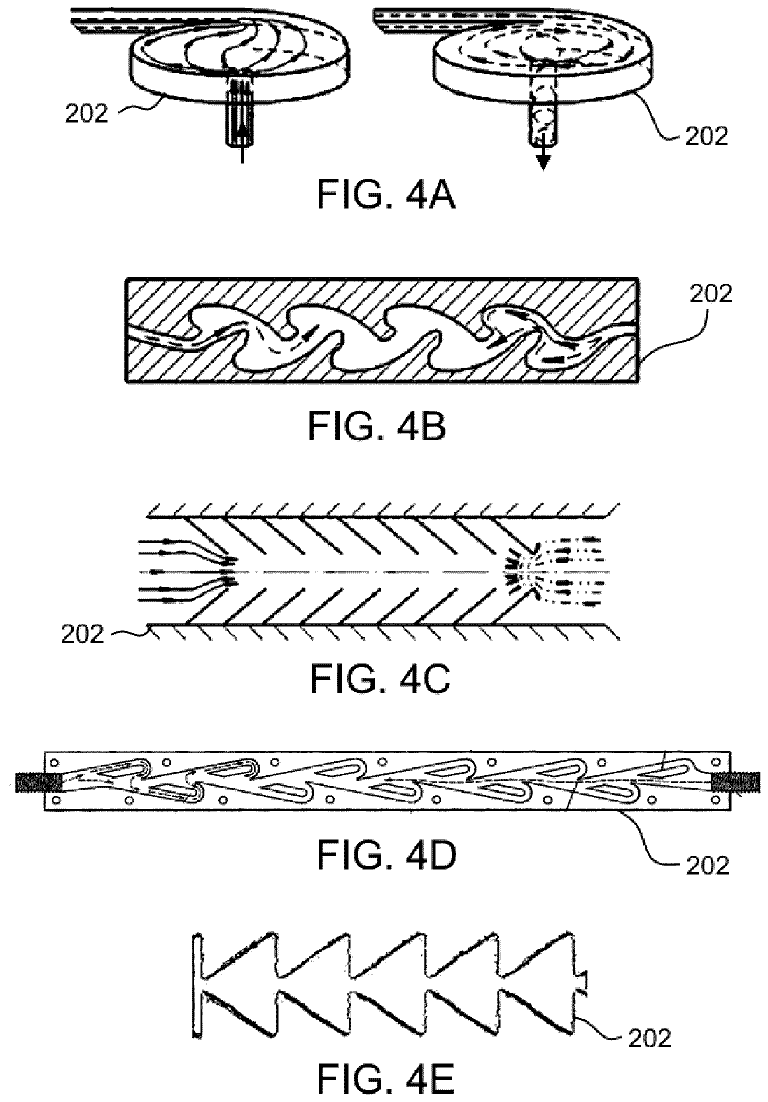

FIGS. 4A-4E illustrate examples of fluidic diodes 202 useable in example embodiment system 200. FIG. 4A illustrates a vortex diode where straight flow in one direction on the left is possible with little resistance, but reverse flow causes significant resistance due to vortex development. FIGS. 4B-4C illustrate diodes 202 that all allow relatively easy passage of flow from left to right but significant flow losses and resistance in the reverse direction. FIGS. 4D-4E illustrate the opposite, where significant flow losses are encountered only in left-to-right flows. Fluidic diodes 202 may be combined and used in any number to develop desired flow flosses and limit reverse flows. U.S. Pat. Nos. 5,303,275 to Kobsa; 9,915,362 to Hampton et al.; 10,354,763 to Loewen et al.; 9,695,654 to Stephenson et al.; and CN Patent Publication 209213295 to Song et al. are all incorporated herein in their entireties and disclose fluidic diodes and systems using the same useable in example embodiments.

Check valves and mechanical valves in the primary coolant supply lines may also be used to prevent reverse flow instead of or in combination with fluidic diodes. For liquid metals systems, fluidic diodes have higher reliability and cannot block forced flow like a mechanical valve that fails closed. Example embodiment reverse flow limitation enable core and reactor designs benefitting from coast down and restricted reverse flow; however they are also useable in designs requiring no coast down and tolerating reverse flow. Example embodiments may further reduce the need to eliminate pressure drops through the heat exchanger and other devices to reduce the hot pool head, which may have significant disadvantages.

By limiting flow reversal through the core during a loss of power event and, even if safe shutdown occurs, example embodiment systems may avoid a momentary reversal of flow allowing high temperature coolant to be further heated by heat still emanating from the fuel source, which may be a threat to core integrity and continued operation of the plant. With proper sizing and number, one-way flow limiters may reduce reverse flow compared to systems in which they are not present by 50% or more, including 90% or more, essentially closing a path to reverse flow. Example embodiments may even go so far as to provide continuous cooling and forward flow for reactor coast down. Example embodiments may supplement or replace redundant power sources such as batteries or generators connected to flywheels, which are complex and subject to their own failure modes including common-cause electrical failures. In this way example embodiments may be safer, less expensive, and/or more reliable for reactor systems. Example embodiments may be compatible with SFR technology, have reduced complexity and required analysis, and/or introduce no new failure modes or low TRL outside of diode effectiveness. This may reduce cost/complexity and/or ensures safe shutdown and protect equipment for restart.

Example embodiment cores may use any materials compatible with an operating nuclear reactor environment, including radiation-resilient materials that maintain their physical characteristics when exposed to high-temperature fluids, liquid metals, and radiation without substantially changing in physical properties, such as becoming substantially radioactive, melting, brittling, retaining/adsorbing radioactive particulates, etc. For example, several known structural materials, including austenitic stainless steels 304 or 316, XM-19, zirconium alloys, nickel alloys, Alloy 600, non-soluble high density plastics etc. may be chosen for any element of components of example embodiment systems. Similarly, direct connections between distinct parts and all other direct contact points may be lubricated, insulated, and/or fabricated of alternating or otherwise compatible materials to prevent seizing, fouling, metal-on-metal reactions, conductive heat loss, etc.

Some example embodiments and methods thus being described, it will be appreciated by one skilled in the art that examples may be varied through routine experimentation and without further inventive activity. For example, although some placements of diodes and coolant risers are shown together in some example embodiments and methods, it is understood that exclusive use of these components at other locations are useable with example embodiments and methods. Variations are not to be regarded as departure from the spirit and scope of the example embodiments, and all such modifications as would be obvious to one skilled in the art are intended to be included within the scope of the following claims.

1. A forward flow enhancer for a nuclear reactor having a hot pool of coolant connected to a cold pool of coolant through a heat exchanger, the enhancer comprising:
a coolant inlet for the reactor;
a coolant riser in fluid communication at a juncture with the coolant inlet, wherein the coolant riser has an elevation of a vertical height to provide a pressure head of the coolant under gravity alone higher than a pressure head of the filled reactor at the juncture.

2. The enhancer of claim 1, further comprising:
an electromagnetic pump connected to the coolant inlet.

3. The enhancer of claim 2, wherein the juncture is after the pump in the direction of the inlet from the pump to the reactor.

4. The enhancer of claim 2, wherein the riser is an annular jacket surrounding the pump.

5. The enhancer of claim 1, wherein the coolant is liquid sodium, and wherein the coolant riser is filled with the liquid sodium to a vertical elevation higher than liquid sodium in the hot pool.

6. The enhancer of claim 1, wherein the riser is a pool above the reactor.

7. The enhancer of claim 1, wherein the coolant riser is a volume configured to contain the coolant and inject the same under gravity into the coolant inlet and does not include a moveable solid structure or electrically-powered component.

8. The enhancer of claim 7, wherein the coolant riser has a volume configured to store an amount of coolant to cool the reactor for a full coast down of the reactor.

9. The enhancer of claim 1, further comprising:
a fluidic diode before the juncture in the direction of the inlet toward the reactor.

10. A forward flow enhancer for a nuclear reactor having a hot pool of coolant connected to a cold pool of coolant through a heat exchanger, the enhancer comprising:
a coolant inlet for the reactor;
a one-way flow limiter in fluid communication with the coolant inlet, wherein the flow limiter allows flow into the reactor and limits flow out of the reactor passively.

11. The enhancer of claim 10, wherein the one-way flow limiter is a fluidic diode.

12. The enhancer of claim 11, wherein the fluidic diode includes no solid moving parts.

13. The enhancer of claim 11, further comprising:
an electromagnetic pump connected to the coolant inlet.

14. The enhancer of claim 13, wherein the fluidic diode is after the pump in the direction of the inlet from the pump to the reactor.

15. The enhancer of claim 14, further comprising:
a coolant riser in fluid communication at a juncture with the coolant inlet after the fluidic diode in the direction, wherein the coolant riser has an elevation of a vertical height to provide a pressure head of the coolant under gravity alone higher than a pressure head of the filled reactor at the juncture.

16. A method of reducing reverse fluid flow through a core of a nuclear reactor having a hot pool of coolant connected to a cold pool of liquid metal coolant through a heat exchanger by at least 50% compared to reverse fluid flow occurring with no pumping or limiting, the method comprising:
injecting the liquid metal coolant from a riser under the force of gravity alone into a coolant inlet of the reactor; and
blocking the liquid metal coolant from moving in the reverse direction after exiting the riser with a one-way flow limiter.

17. The method of claim 16, wherein the one-way flow limiter is a fluidic diode.

18. The method of claim 16, wherein the injecting is performed while the reactor is scrammed or shutdown.

19. The method of claim 18, wherein the injecting is performed during an entire coast down period of the reactor.

20. The method of claim 16, wherein the reverse fluid flow is reduced by 95%.
